(19) United States
(12) Patent Application Publication
(10) Pub. No.: US 2025/0316802 A1
(43) Pub. Date: Oct. 9, 2025

(54) ALL-SOLID-STATE BATTERY

(71) Applicant: SAMSUNG SDI CO., LTD., Yongin-si, Gyeonggi-do (KR)

(72) Inventors: Eungyeong LEE, Yongin-si, Gyeonggi-do (KR); Young Gyoon RYU, Yongin-si, Gyeonggi-do (KR); Kyusung PARK, Yongin-si, Gyeonggi-do (KR); Byeongdo KWAK, Yongin-si, Gyeonggi-do (KR); Ik Hwan CHO, Yongin-si, Gyeonggi-do (KR)

(21) Appl. No.: 18/877,449

(22) PCT Filed: Nov. 3, 2023
(86) PCT No.: PCT/KR2023/017512

§ 371 Date: Dec. 20, 2024

(30) Foreign Application Priority Data
Nov. 11, 2022 (KR) 10-2022-0150998

(51) Int. Cl. H01M 50/14; H01M 10/0562; H01M 10/0585; H01M 50/103; H01M 50/271; H01M 50/54; H01M 50/55; H01M 50/553

(52) U.S. Cl. CPC H01M 50/14; H01M 10/0562; H01M 10/0585; H01M 50/103; H01M 50/271; H01M 50/54; H01M 50/55; H01M 50/553

(57) ABSTRACT

One embodiment provides an all-solid-state battery in which a cell stack can be inserted into a case.

The all-solid-state battery includes a cell stack formed by stacking a first electrode plate, a solid electrolyte layer, and a second electrode plate, an inner case formed by coupling a first case (lower) and a second case with each other, each embedding both sides of the cell stack, a buffer tape attached to an outer surface of the inner case, an outer case embedding the inner case to which the buffer tape is attached, and a cap plate coupled to an opening of the outer case.

### TECHNICAL FIELD

The present invention relates to an all-solid-state battery, and more particularly, to an all-solid-state battery that accommodates a cell stack in an outer case by applying an inner case.

### BACKGROUND ART

A prismatic lithium ion battery is configured by wrapping an outside of an electrode assembly including a cathode plate, a separator, and an anode plate with an adhesive tape, fixing the electrode assembly, and inserting the electrode assembly into an inside of a case. A thickness of the electrode assembly wrapped with the tape is smaller than a gap of a space inside the case.

An all solid-state battery has a solid electrolyte film, which performs the functions of the separator and the electrolyte, provided between the cathode plate and the anode plate. In order to implement high energy density, the all solid-state battery uses lithium metal as an anode.

When the lithium metal is used as an anode, a layer volume is expanded and reduced in the anode plate during a charging and discharging process. This change is much more severe than the change in the anode plate that occurs in an active material due to the insertion and desorption of lithium ions in a lithium ion battery.

During the charging process, the lithium ions discharged from the cathode plate are plated as lithium metal on the anode plate, and are stripped again during the discharging process. Therefore, the volume of the anode plate changes during the charging and discharging.

Meanwhile, the change in volume of the anode plate is structurally unstable when viewed from the perspective of the entire cell, and is unstable in terms of the growth of lithium dendrites. Therefore, in order to absorb the change in partial pressure caused by the lithium plating and stripping on the anode plate and distribute the force, an elastic sheet may be inserted between current collectors of the anode plate and the cathode plate.

The elastic sheet is inserted by forming compressible foam for the purpose of volume compensation inside the cell stack. However, the elastic sheet increases the volume of the cell stack compared to an internal space of the case, making the process of inserting the cell stack into the case difficult.

### DISCLOSURE

### Technical Problem

The present disclosure attempts to provide an all-solid-state battery in which a cell stack can be inserted into a case. In addition, the present disclosure attempts to provide an all-solid-state battery in which a cell stack is inserted into an outer case by applying an inner case to accommodate the cell stack.

### Technical Solution

According to an embodiment, an all-solid-state battery includes a cell stack formed by stacking a first electrode plate, a solid electrolyte layer, and a second electrode plate, an inner case formed by coupling a first case (lower) and a second case with each other, each embedding both sides of the cell stack, a buffer tape attached to an outer surface of the inner case, an outer case embedding the inner case to which the buffer tape is attached, and a cap plate coupled to an opening of the outer case.

At least one of the outer case and the cap plate may be electrically connected to the first electrode plate, and an electrode terminal installed in the cap plate with an insulating member interposed therebetween may be electrically connected to the second electrode plate.

The first electrode plate may be connected to the cap plate by a first electrode tab and may be connected to the outer case welded to the cap plate, and the second electrode plate may be connected to the electrode terminal by a second electrode tab.

The first case and the second case may be coupled to each other in a stacking direction of the cell stack and overlap in the stacking direction.

The first case may be electrically connected by being connected to the first electrode plate and in direct contact with the outer case.

In the overlapping portion, the first case may have first insulating parts formed on inner and outer sides of the opening, the second case may have second insulating parts formed on the inner and outer sides of the opening, and the first insulating part and the second insulating part may be tightly coupled to each other.

The second insulating part may further include an insulating extension part formed on an outer surface of the second case facing an inner surface of the outer case.

The buffer tape may be wound around and attached to the outer surfaces of the first case and the second case while going in a circumferential direction of the cell stack along an overlap line of the first case and the second case.

The overlap line may be formed between a first electrode tab connected to the first electrode plate and a second electrode tab connected to the second electrode plate.

A maximum width of the buffer tape may be set between the first electrode tab and the second electrode tab in the stacking direction of the cell stack. The buffer tape may be formed of acrylic foam or urethane foam.

The buffer tape may have a foamed structure as needed from polyurethane-based, polyacrylic-based, polyacrylic-urethane composite, and rubber-based materials.

The buffer tape may have a shock absorption rate of 45% or more and have an adhesive component on at least one surface thereof.

The buffer tape may be wound around and attached to the outer surfaces of the first case and the second case while going in a width direction of the cell stack and going in a height direction of the cell stack by intersecting the overlap line of the first case and the second case and intersecting a longitudinal direction of the cell stack.

A maximum width of the buffer tape may be set to an entire length of the cell stack along the longitudinal direction of the cell stack.

The buffer tape may include a first tape that is wound around and attached to the outer surfaces of the first case and the second case while going in a circumferential direction of the cell stack along the overlap line of the first case and the second case, and a second tape that is wound around and attached to the first tape and the outer surfaces of the first case and the second case while going in a width direction of the cell stack and going in a height direction of the cell stack by intersecting the overlap line and intersecting the longitudinal direction of the cell stack.

### Advantageous Effect

According to an all-solid-state battery according to an embodiment of the present disclosure, the cell stack is accommodated in the inner case, thereby enabling the cell stack to be inserted into the outer case. In addition, according to an embodiment, the buffer tape is provided on the outer surface of the inner case, thereby absorbing the vibration or shock through the buffer tape disposed between the inner case and the outer case while enabling the cell stack to be inserted into the outer case. Accordingly, it is possible to prevent the electrode tab located between the inner case and the outer case from being cut.

### DESCRIPTION OF THE DRAWINGS

FIG. 1 is an exploded perspective view of an all-solid-state battery according to a first embodiment of the present disclosure.

FIG. 2 is an exploded perspective view of a cell assembly and an inner case applied to FIG. 1.

FIG. 3 is a cross-sectional view taken along line III-III of FIG. 1.

FIG. 4 is a cross-sectional view taken along line IV-IV of FIG. 1.

FIG. 5 is an exploded perspective view of an all-solid-state battery according to a second embodiment of the present disclosure.

FIG. 6 is a cross-sectional view taken along line VI-VI of FIG. 5.

FIG. 7 is an exploded perspective view of an all-solid-state battery according to a third embodiment of the present disclosure.

### MODE FOR INVENTION

Hereinafter, the present disclosure will be described more fully hereinafter with reference to the accompanying drawings, in which embodiments of the disclosure are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

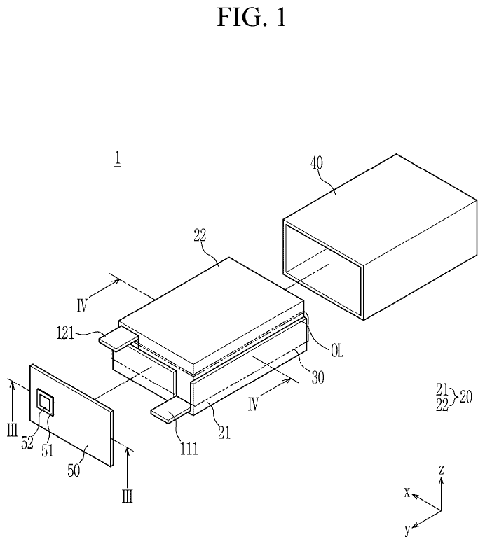

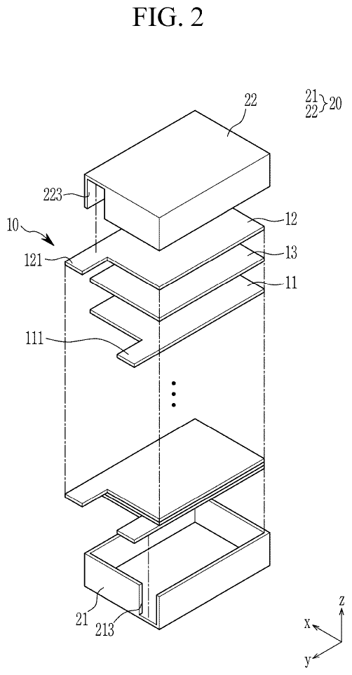

FIG. 1 is an exploded perspective view of an all-solid-state battery according to a first embodiment of the present disclosure. FIG. 2 is an exploded perspective view of a cell assembly and an inner case applied to FIG. 1. Referring to FIGS. 1 and 2, an all-solid-state battery 1 of a first embodiment includes a cell stack 10, an inner case 20, a buffer tape 30, and an outer case 40.

The cell stack 10 includes a first electrode plate 11, a solid electrolyte layer 13, and a second electrode plate 12, and is configured by stacking the first electrode plate 11 and the second electrode plate 12 on both surfaces of the solid electrolyte layer 13. As an example, the first electrode plate 11 may be configured as an anode plate, and the second electrode plate 12 may be configured as a cathode plate.

The cell stack 10 may form a unit cell in a mono-cell or bi-cell structure by stacking a structure of a first electrode plate 11, a solid electrolyte layer 13, and a second electrode plate 12.

That is, the bi-cell is formed by providing solid electrolyte layers on both surfaces of the cathode plate and arranging an anode plate on each solid electrolyte layer. In addition, the mono-cell is formed by sequentially stacking a solid electrolyte layer and an anode plate on one side of the cathode plate.

The first electrode plate 11, i.e., the anode plate, includes an anode collector made of stainless steel or nickel-coated copper (Ni-coated Cu) and an anode composite layer formed by applying slurry to one surface of the anode collector.

The anode plate may not have an anode composite layer and may be formed only with an anode collector. In this case, a lithium plating layer plated from the anode current collector acts as the anode composite layer. The anode current collector has a first electrode tab 111 that protrudes laterally more than the solid electrolyte layer 13.

The second electrode plate 12, i.e., the cathode plate, is formed by applying a cathode composite layer to the cathode current collector. The cathode plate includes a cathode current collector made of aluminum and the cathode composite layer formed by applying slurry to both surfaces of the cathode current collector. That is, the cathode composite layer enables lithium ions to enter and exit during the charging and discharging. The anode current collector has a second electrode tab 121 that protrudes laterally more than the solid electrolyte layer 13.

The first electrode tabs 111 overlaps each other in a stacking direction and are drawn out to one side of the cell stack 10. The second electrode tabs 121 overlaps each other in the stacking direction and are drawn out to one side of the cell stack 10.

In this case, the first electrode tabs 111 and the second electrode tabs 121 may be drawn out in the same direction of the cell stack 10 as illustrated in FIGS. 1 and 2. Although not illustrated, the first electrode tabs and the second electrode tabs may be drawn out to opposite sides of the cell stack, respectively.

When the cell stack 10 is charged, lithium ions from the cathode plate 12 pass through the solid electrolyte layer 13 and are plated on one side of the anode current collector of the anode plate 11, thereby forming a lithium plating layer. During the discharging, the lithium ions from the lithium plating layer of the anode plate 11 are dissociated and move to the cathode plate 12 through the solid electrolyte layer 13.

In this way, the cell stack 10 is formed by the lithium ions from the cathode plate 12 during the charging process being plated as the lithium metal on the anode plate 11, and being stripped again during the discharging process. Therefore, a volume of the anode plate 11 changes during the charging and discharging. In other words, a volume of the cell stack 10 changes during the charging and discharging.

The inner case 20 is formed by coupling the first case 21 and the second case 22 with each other, each embedding both surfaces of the cell stack 10. As an example, the first case 21 accommodates a portion of a lower side of the cell stack 10 on the anode plate 11 side, which is disposed at the lowest side.

The second case 22 accommodates the other portion of an upper side of the cell stack 10. The first and second cases 21 and 22 are provided on both sides of the stacking direction of the cell stack 10 and are coupled to each other in the stacking direction to accommodate the cell stack 10 inside thereof.

The buffer tape 30 is attached to an outer surface of the inner case 20. The outer case 40 houses the inner case 20 to which the buffer tape 30 is attached. Therefore, the buffer tape 30 may absorb vibration or shock between the inner case 20 and the outer case 40. A cap plate 50 is coupled to an opening of the outer case 40 to form the all-solid-state battery 1.

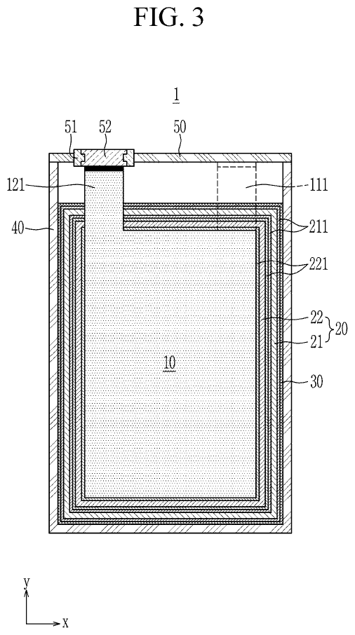

FIG. 3 is a cross-sectional view taken along line III-III of FIG. 1. Referring to FIGS. 1 to 3, the first electrode plate 11, i.e., the anode plate, is electrically connected to at least one of the outer case 40 and the cap plate 50.

The first electrode plate 11 is connected to the cap plate 50 by the first electrode tab 111, and since the cap plate 50 is welded to the outer case 40, it is also electrically connected to the outer case 50.

The second electrode plate 12, i.e., the cathode plate, is electrically connected to the electrode terminal 52 installed in the cap plate 50 with an insulating member 51 interposed therebetween. Therefore, the electrode terminal 52 becomes a cathode, and the outer case 40 and the cap plate 50, which are welded to each other, become an anode.

As an example, the insulating member 51 is made of silicone, polytetrafluoroethylene (PTFE), or a fluororesin, and the electrode terminal 52 is surrounded by an insulating member 51 such as a sealant. Therefore, the electrode terminal 52 and the cap plate 50 form independent metal surfaces having different polarities.

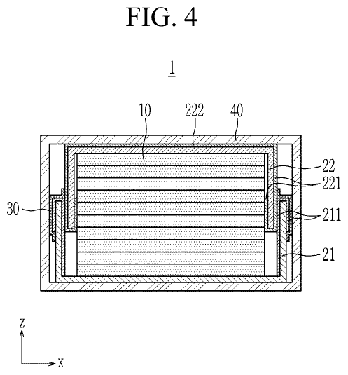

FIG. 4 is a cross-sectional view taken along line IV-IV of FIG. 1. Referring to FIGS. 1, 3, and 4, the first case 21 and the second case 22 are connected to each other in the stacking direction (up-down direction in FIG. 4) of the cell stack 10 and overlap in the stacking direction to form the inner case 20 that accommodates the cell stack 10.

The first case 21 may be connected to the first electrode plate 11 and be electrically connected by directly contacting the outer case 40. In this case, the first electrode tab 111 of the first electrode plate 11 may not be provided, and the configuration of the first electrode plate 11 may be simplified. For convenience, FIG. 3 illustrates a configuration in which the first electrode tab 111 of the first electrode plate 11 is welded to the inner surface of the cap plate 50.

In the overlapping portion, the first case 21 forms a first insulating part 211 on inner and outer sides of the opening. The second case 22 forms a second insulating part 221 on the inner and outer sides of the opening. When the first and second cases 21 and 22 are coupled, the first insulating part 211 and the second insulating part 221 are tightly coupled to each other and electrically insulated from each other.

The second insulating part 221 further includes an insulating extension part 222 formed on the outer surface of the second case 22. The insulating extension part 222 is formed on the outer surface of the second case 22 so as to face the inner surface of the outer case 40, thereby electrically insulating the second case 22 and the outer case 40 from each other.

In the inner case 20, an overlap line OL is formed between the first electrode tab 111 connected to the first electrode plate 11 and the second electrode tab 121 connected to the second electrode plate 12. The first electrode tab 111 and the second electrode tab 121 are spaced apart in a width direction (x-axis direction) of the cell stack 10 and spaced apart in the stacking direction (z-axis direction).

In order to draw out the first electrode tab 111, the first case 21 has a first open groove 213 provided on one side of the cell stack 10 in a length direction (y-axis direction). The first open groove 213 is opened toward the first electrode tab 111 and the second case 22.

In order to draw out the second electrode tab 121, the second case 22 has a second open groove 223 provided on one side of the cell stack 10 in a length direction (y-axis direction). The second open groove 223 is opened toward the second electrode tab 121 and the first case 21.

Therefore, when the first and second cases 21 and 22 are coupled to overlap each other, the cell stack 10 is accommodated inside the first and second cases 21 and 22, and the first and second electrode tabs 111 and 121 may be drawn out into the first and second open grooves 213 and 223.

The buffer tape 30 is wound around and attached to the outer surfaces of the first case 21 and the second case 22 while going in a circumferential direction of the cell stack 10 along the overlap line OL of the first and second cases 21 and 22.

In this case, a maximum width of the buffer tape 30 is set between the first electrode tab 111 and the second electrode tab 121 in the stacking direction (z-axis direction) of the cell stack 10. A width of the buffer tape 30 may be set to a size that may exhibit the required buffering performance.

As an example, the buffer tape 30 may be formed of acrylic foam or urethane foam. In addition, the buffer tape 30 has a shock absorption rate of 45% or more and has an adhesive component on at least one surface, thereby facilitating handling when attached to the first and second cases 21 and 22.

The buffer tape 30 is made of polyurethane-based, polyacrylic-based, polyacrylic-urethane composite, and rubber-based materials and has a foamed structure as needed, so it may have excellent shock absorption rate between the inner case 20 and the outer case 40. Therefore, the buffer tape 30 may prevent damage to the first electrode tab 111 and the second electrode tab 121 between the cell stack 10 and the cap plate 50.

Hereinafter, various embodiments of the present disclosure will be described. Compared to the first embodiment and the above-described embodiments, descriptions of the same configurations will be omitted and descriptions of different configurations will be described.

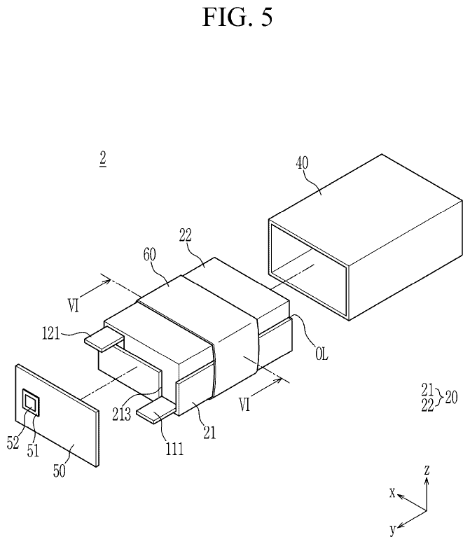

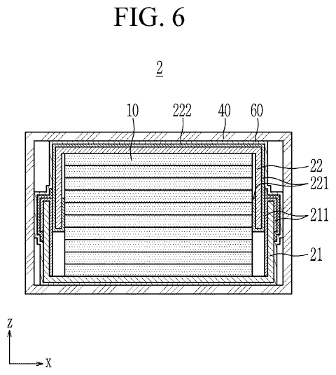

FIG. 5 is an exploded perspective view of an all-solid-state battery according to a second embodiment of the present disclosure. FIG. 6 is a cross-sectional view taken along line VI-VI of FIG. 5. Referring to FIGS. 5 and 6, in an all-solid-state battery 2 of the second embodiment, a buffer tape 60 is wound around and attached to the outer surfaces of the first case 21 and the second case 22 while going in the width direction (x-axis direction) of the cell stack 10 and in a height direction (z-axis direction) of the cell stack 10 by intersecting the overlap line OL of the first and second cases 21 and 22 and intersecting the longitudinal direction (y-axis direction) of the cell stack 10.

In this case, a maximum width of the buffer tape 60 is set to the entire length of the cell stack 10 along the longitudinal direction (y-axis direction) of the cell stack 10. A width of the buffer tape 60 may be set to a size that may exhibit the required buffering performance.

When the cell stack 10 is larger in the width direction (x-axis direction) than in the length direction (y-axis direction), the buffer performance by the buffer tape 60 of the second embodiment may be superior to the buffer performance by the buffer tape 30 of the first embodiment.

That is, since the buffer tape 60 in the second embodiment exhibits superior buffer performance between the cell stack 10 and the outer case 40, the damage of the first electrode tab 111 and the second electrode tab 121 between the cell stack 10 and the cap plate 50 may be further prevented.

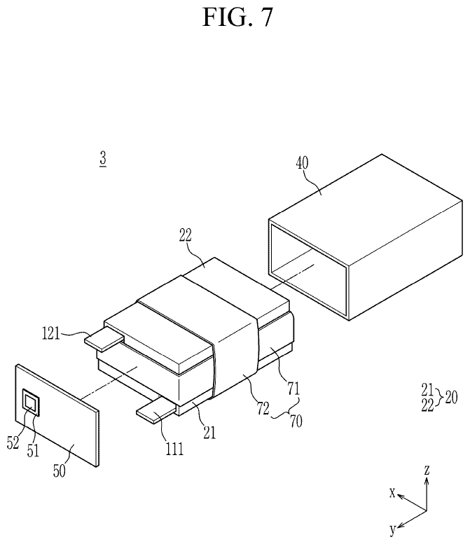

FIG. 7 is an exploded perspective view of an all-solid-state battery according to a third embodiment of the present disclosure. Referring to FIG. 7, in an all-solid-state battery 3 of the third embodiment, the buffer tape 70 includes a first tape 71 and a second tape 72. The first tape 71 corresponds to the buffer tape 30 of the first embodiment, and the second tape 72 corresponds to the buffer tape 60 of the second embodiment.

That, the first tape 71 is wound around and attached to the outer surfaces of the first case 21 and the second case 22 while going in a circumferential direction of the cell stack 10 along the overlap line OL of the first and second cases 21 and 22.

The second tape 72 is wound around and attached to the outer surfaces of the first tape 71 and the first case 21 and the second case 22 while going in the width direction (x-axis direction) of the cell stack 10 and going in the height direction (z-axis direction) of the cell stack 10 by intersecting the overlap line OL of the first and second cases 21 and 22 and intersecting the longitudinal direction (y-axis direction) of the cell stack 10.

The buffer tape 70 of the third embodiment may further enhance the buffer performance by combining the buffer tape 30 of the first embodiment and the buffer tape 60 of the second embodiment. That is, since the buffer tape 70 in the third embodiment exhibits superior buffer performance between the cell stack 10 and the outer case 40, the damage of the first electrode tab 111 and the second electrode tab 121 between the cell stack 10 and the cap plate 50 may be further prevented.

Although preferred embodiments of the present disclosure have been described above, the present invention is not limited thereto, and the present disclosure can be variously modified within the scope of the claims, the description of the invention, and the appended drawings, and it is natural that various modifications also fall within the scope of the present disclosure.

### DESCRIPTION OF SYMBOLS

1, 2, 3: All-solid-state battery 10: Cell stack
11: First electrode plate 12: Second electrode plate
13: Solid electrolyte layer 20: Inner case
30, 60, 70: Buffer tape 40: Outer case
50: Cap plate 51: Insulating member
52: Electrode terminal 71: First tape
72: Second tape 111: First electrode tab
121: Second electrode tab 211: First insulating part
221: Second insulating part 222: Insulating extension part
213: First open groove 223: Second open groove
OL: Overlap line

1. An all-solid-state battery, comprising:
a cell stack formed by stacking a first electrode plate, a solid electrolyte layer, and a second electrode plate;
an inner case formed by coupling a first case and a second case with each other, each embedding both sides of the cell stack;
a buffer tape attached to an outer surface of the inner case;
an outer case embedding the inner case to which the buffer tape is attached; and
a cap plate coupled to an opening of the outer case.

2. The all-solid-state battery as claimed in claim 1, wherein:
at least one of the outer case and the cap plate is electrically connected to the first electrode plate, and
an electrode terminal installed in the cap plate with an insulating member interposed therebetween is electrically connected to the second electrode plate.

3. The all-solid-state battery as claimed in claim 2, wherein:
the first electrode plate is connected to the cap plate by a first electrode tab and is connected to the outer case welded to the cap plate, and
the second electrode plate is connected to the electrode terminal by a second electrode tab.

4. The all-solid-state battery as claimed in claim 1, wherein:
the first case and the second case
are coupled to each other in a stacking direction of the cell stack and overlap in the stacking direction.

5. The all-solid-state battery as claimed in claim 4, wherein:
the first case is electrically connected by being connected to the first electrode plate and in direct contact with the outer case.

6. The all-solid-state battery as claimed in claim 4, wherein:
in the overlapping portion,
the first case has first insulating parts formed on inner and outer sides of the opening,
the second case has second insulating parts formed on the inner and outer sides of the opening, and
the first insulating part and the second insulating part are tightly coupled to each other.

7. The all-solid-state battery as claimed in claim 6, wherein:
the second insulating part further includes an insulating extension part formed on an outer surface of the second case facing an inner surface of the outer case.

8. The all-solid-state battery as claimed in claim 4, wherein:
the buffer tape
is wound around and attached to the outer surfaces of the first case and the second case while going in a circumferential direction of the cell stack along an overlap line of the first case and the second case.

9. The all-solid-state battery as claimed in claim 8, wherein:
the overlap line is formed between a first electrode tab connected to the first electrode plate and a second electrode tab connected to the second electrode plate.

10. The all-solid-state battery as claimed in claim 9, wherein:
a maximum width of the buffer tape
is set between the first electrode tab and the second electrode tab in the stacking direction of the cell stack.

11. The all-solid-state battery as claimed in claim 1, wherein:
the buffer tape is formed of acrylic foam or urethane foam.

12. The all-solid-state battery as claimed in claim 1, wherein:
the buffer tape has a foamed structure as needed from polyurethane-based, polyacrylic-based, polyacrylic-urethane composite, and rubber-based materials.

13. The all-solid-state battery as claimed in claim 12, wherein:
the buffer tape has a shock absorption rate of 45% or more and has an adhesive component on at least one surface thereof.

14. The all-solid-state battery as claimed in claim 4, wherein:
the buffer tape
is wound around and attached to the outer surfaces of the first case and the second case while going in a width direction of the cell stack and going in a height direction of the cell stack by intersecting the overlap line of the first case and the second case and intersecting a longitudinal direction of the cell stack.

15. The all-solid-state battery as claimed in claim 14, wherein:
a maximum width of the buffer tape
is set to an entire length of the cell stack along the longitudinal direction of the cell stack.

16. The all-solid-state battery as claimed in claim 4, wherein:
the buffer tape includes
a first tape that is wound around and attached to the outer surfaces of the first case and the second case while going in a circumferential direction of the cell stack along the overlap line of the first case and the second case, and
a second tape that is wound around and attached to the first tape and the outer surfaces of the first case and the second case while going in a width direction of the cell stack and going in a height direction of the cell stack by intersecting the overlap line and intersecting the longitudinal direction of the cell stack.
